(19) United States
(12) Patent Application Publication
(10) Pub. No.: US 2008/0211470 A1
(43) Pub. Date: Sep. 4, 2008

(54) Auto discharge linear regulator and method for the same

(75) Inventors: Tzu-Huan Chiu, Chupei City (TW); Kwan-Jen Chu, Chupei City (TW); Chien-Ping Lu, Chupei City (TW)

Correspondence Address: TUNG & ASSOCIATES / RANDY W. TUNG, ESQ., 838 W. LONG LAKE RD., SUITE 120, BLOOMFIELD HILLS, MI, 48302, US

(73) Assignee: Richtek Technology Corporation

(21) Appl. No.: 12/069,966

(22) Filed: Feb. 13, 2008

(30) Foreign Application Priority Data
Mar. 3, 2007 (TW) 96107329

(51) Int. Cl. G05F 1/00

(52) U.S. Cl. 323/273

(57) ABSTRACT

The present invention discloses an auto discharge linear regulator comprising: a basic linear regulator for converting an input voltage to an output voltage at an output node; a load detector circuit for detecting the load condition at the output node; and an discharge control circuit under control by the load detector circuit for discharging the voltage at the output node.

### FIELD OF INVENTION

The present invention relates to an auto discharge linear regulator, in particular to a linear regulator without output overshoot effect when its load changes from heavy load to light load or no load, and a corresponding method.

### DESCRIPTION OF RELATED ART

A low drop-out regulator (LDO) circuit is a typical example of a linear regulator. FIG. 1 shows a conventional source mode LDO 10, which is advantageous in its low quiescent current, low voltage drop, and quick response to heavy load, but disadvantageous in that it provides no current sinking function. When the load changes from heavy load to no load, the output voltage will overshoot (i.e., it will greatly exceed the required normal operation voltage), and because there is no load, it requires a long time to release the charges, for the output voltage to drop to the normal operation voltage.

FIGS. 2-4 show several conventional circuits to try to solve the above problem. These prior art circuits adjust the output voltage by modifying the circuitry relating to the error amplifier in the LDO circuit. All of them still have the drawbacks that the circuit response is not fast enough, and that there is no proper mechanism to release charges (i.e., to discharge).

In view of the foregoing, it is desired to provide a linear regulator with discharge function and fast response when its load changes from heavy load to light load or no load. The definitions of heavy load, light load, and no load are as follows: “no load”: the load terminal consumes no current except leakage current; “light load”: besides leakage current, the load terminal consumes relatively small current in comparison with “heavy load” condition; “heavy load”: besides leakage current, the load terminal consumes relatively large current in comparison with “light load” condition.

### SUMMARY

A first objective of the present invention is to provide an auto discharge linear regulator to solve the problems in the prior art.

A second objective of the present invention is to provide an auto discharge method.

In accordance with the foregoing and other objectives of the present invention, and from one aspect of the present invention, an auto discharge linear regulator comprises: a basic linear regulator for converting an input voltage to an output voltage at an output node; a load detector circuit for detecting the load condition at the output node; and an discharge control circuit under control by the load detector circuit for discharging the voltage at the output node.

Preferably, the discharge control circuit includes a path electrically connecting the output node to ground, the path being provided with a switch controlled by the load detector circuit. More preferably, the load detector circuit includes a timing circuit to control the ON time of the switch.

From another aspect of the present invention, an auto discharge method comprises the steps of: providing an output node electrically connected with a load; providing a discharging path for discharging the voltage at the output node; and detecting the load condition such that the discharging path is conductive when the load changes from heavy load to light load, or from heavy load to no load.

It is to be understood that both the foregoing general description and the following detailed description are provided as examples, for illustration but not for limiting the scope of the invention.

### BRIEF DESCRIPTION OF THE DRAWINGS

These and other features, aspects, and advantages of the present invention will become better understood with regard to the following description, appended claims, and accompanying drawings.

FIG. 1 is a schematic circuit diagram of a conventional source mode LDO circuit.

FIGS. 2-4 show three conventional circuits.

FIG. 5 is a schematic circuit diagram showing a preferred embodiment of the present invention.

FIG. 6 shows an embodiment of the present invention in more detail.

FIG. 7 shows, in even more detail, an embodiment of the present invention which is embodied by analog circuit devices.

FIG. 8 is a waveform diagram showing the waveforms at certain nodes in the circuit of FIG. 7.

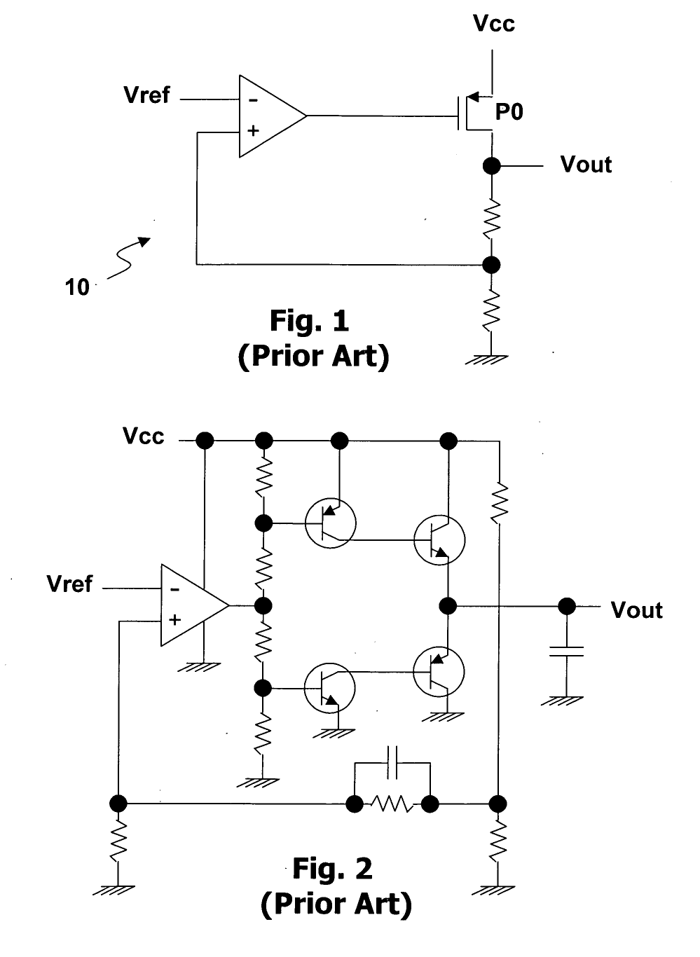

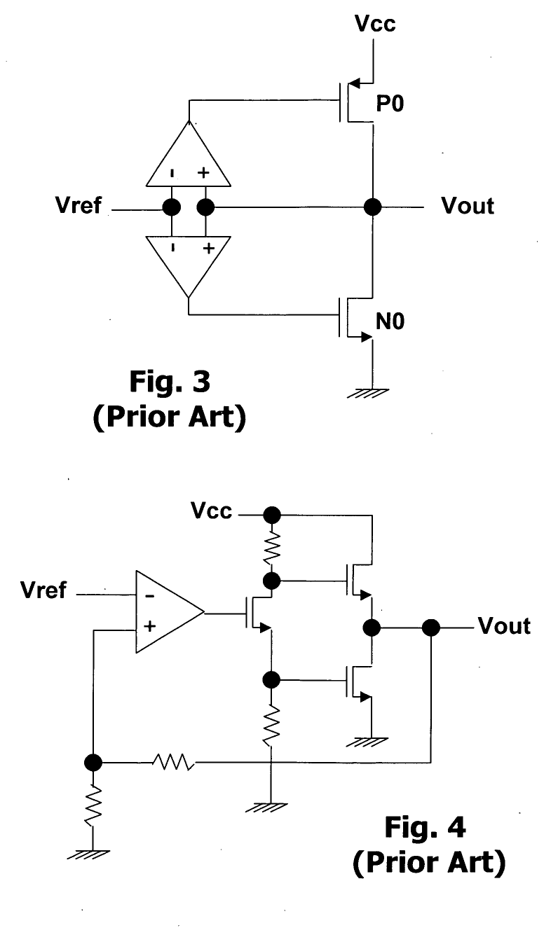

### DESCRIPTION OF THE PREFERRED EMBODIMENTS

Referring to the schematic circuit diagram of FIG. 5, the present invention will be explained in detail with reference to an LDO circuit as an example. As shown in the figure, the auto discharge linear regulator 20 of the present embodiment includes a basic linear regulator 12, a load detection circuit 24 and a discharge control circuit 26. The load detection circuit 24 is capable of activating the discharge control circuit 26 to discharge the voltage at the node Vout when the load of the auto discharge linear regulator 20 changes from heavy load to light load or no load.

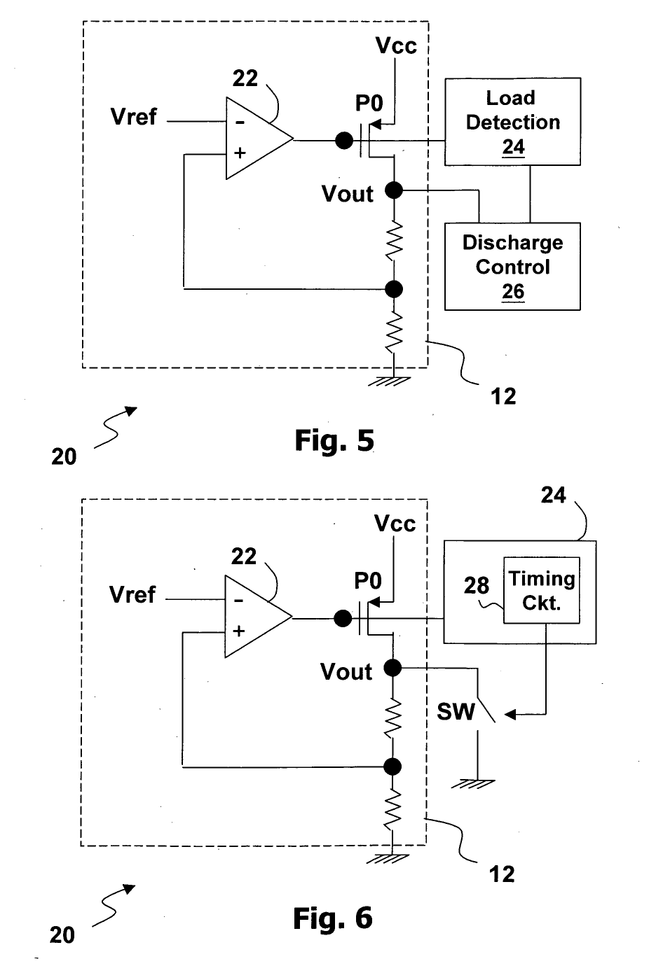

FIG. 6 shows, by way of example, a more detailed circuit structure to embody the circuit of FIG. 5. The discharge control circuit 26 preferably includes a switch SW which is turned ON when the load changes from heavy load to light load or no load, to speed up discharging from the node Vout. More preferably, the load detection circuit 24 is provided with a timing circuit 28 to control the ON time of the switch SW. As an example, the circuit of FIG. 6 may be embodied by an analog circuit as described below. Note that this is not the only way to embody the present invention; there are various ways to achieve the same purpose under the spirit of the present invention.

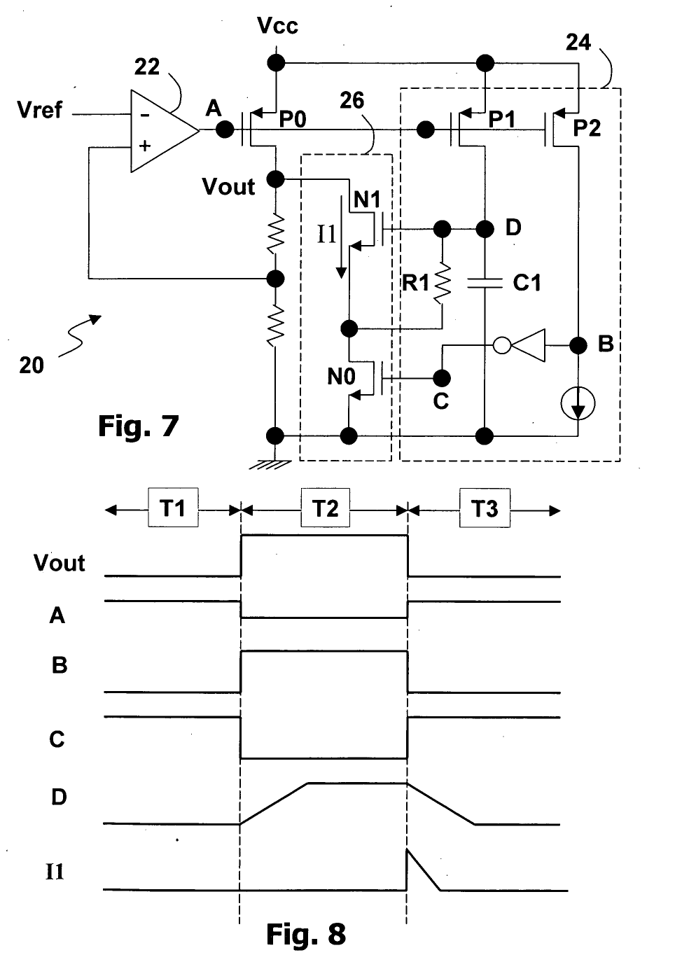

Referring to the circuit of FIG. 7 with reference to the waveforms of FIG. 8, during the time period T1 of light load or no load, the node A is at high level; thus, the power transistor P0 is in low conduction state, and the transistor P2 is also in low conduction state, so that the node B is at low level, and the node C, which is inverted from the node B, is at high level. The transistor N0 is thus ON, but because the transistor P1 is in low conduction state, the node D is at low level, and the transistor N1 is OFF.

During the time period T2, the load changes to heavy load; the feedback signal inputted to the positive input of the error amplifier 22 causes its output (the node A) to decrease. The transistor P2 thereby shifts to high conduction state; the voltage at the node B increases to high level, and the node C becomes low, so that the transistor N0 is turned OFF. However, because the transistor P1 is in high conduction state, current passing through the transistor P1 charges the capacitor C1, to increase the voltage at the node D.

During the time period T3, the load changes from heavy load to no load or light load again; the feedback signal inputted to the positive input of the error amplifier 22 causes its output (the node A) to increase. The transistor P2 thereby shifts to low conduction state; the voltage at the node B drops to low level, and the node C becomes high, so that the transistor N0 is turned ON. In addition, because of the charges accumulated in the capacitor C1, the node D is at high level, and thus the transistor N1 is also turned ON. The node Vout is discharged through a path including the transistors N1 and N0, to quickly decrease its voltage level. The charges accumulated in the capacitor C1 are discharged through a path including the resistor R1 and the transistor N0, so that the voltage at the node D gradually decreases, to turn OFF the transistor N1; the current I1 stops accordingly. In other words, after the discharge function is activated for a predetermined period of time, the transistor N1 is no longer in conduction, to cut off the discharging path.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the present invention may be applied to other linear regulators other than the shown LDO circuit. In the shown embodiments, the load detection circuit 24 detects the output of the error amplifier 22, because it reflects the variation in the output voltage; however, this is not the only way to design the load detection circuit 24. As an example, the load detection circuit 24 can detect the feedback voltage, which is a dividend voltage of the output voltage at the node Vout. As a further example, in the embodiment of FIG. 7, the key is to provide a temporary discharging function to the node Vout at the initial stage of the time period T3 when the load just changes from heavy load to light load or no load; the length of the discharging time period may be controlled by any timing circuit other than the analog capacitor circuit as shown. In view of the foregoing, it is intended that the present invention cover all such and other modifications and variations, which should be interpreted to fall within the scope of the following claims and their equivalents.

What is claimed is:

1. An auto discharge linear regulator comprising:
a basic linear regulator for converting an input voltage to an output voltage at an output node;
a load detector circuit for detecting the load condition at the output node; and
an discharge control circuit under control by the load detector circuit for discharging the voltage at the output node.

2. The auto discharge linear regulator of claim 1, wherein the basic linear regulator is a low drop-out regulator circuit.

3. The auto discharge linear regulator of claim 1, wherein the discharge control circuit includes a path electrically connecting the output node to ground, the path being provided with a switch controlled by the load detector circuit.

4. The auto discharge linear regulator of claim 3, wherein the load detector circuit includes a timing circuit to control the ON time of the switch.

5. The auto discharge linear regulator of claim 4, wherein the timing circuit includes a capacitor which controls the ON time of the switch by its discharging.

6. An auto discharge method comprises the steps of:
(A) providing an output node electrically connected with a load;
(B) providing a discharging path for discharging the voltage at the output node; and
(C) detecting the load condition such that the discharging path is conductive when the load changes from heavy load to light load, or from heavy load to no load.

7. The auto discharge method of claim 6, further comprising: (D) after the discharging path is conductive for a predetermined period of time, cutting off the discharging path.

8. The auto discharge method of claim 7, wherein the discharging path is provided with a switch, and wherein:
the step (C) includes:
(C1) charging a capacitor; and
(C2) turning ON the switch by the voltage across the capacitor, and
the step (D) includes:
(D1) discharging the capacitor to turn OFF the switch.

9. The auto discharge method of claim 6, wherein the voltage at the output node is controlled by a linear regulator which includes a power transistor, and wherein the step (C) includes:
(C3) detecting the gate voltage of the power transistor; and
(C4) when the variation of the gate voltage indicates that the load changes from heavy load to light load, or from heavy load to no load, conducting discharging path.

10. The auto discharge method of claim 6, wherein the voltage at the output node is controlled by a linear regulator which includes a power transistor, and wherein the step (C) includes:
(C3′) detecting a dividend voltage of the voltage at the output node; and
(C4) when the variation of the dividend voltage indicates that the load changes from heavy load to light load, or from heavy load to no load, conducting discharging path.
